(19) United States
(12) Patent Application Publication
(10) Pub. No.: US 2009/0309495 A1
(43) Pub. Date: Dec. 17, 2009

(54) PLASMA DISPLAY PANEL

(76) Inventors: Koji Ohira, Miyazaki (JP); Noriaki Setoguchi, Miyazaki (JP)

Correspondence Address: MILES & STOCKBRIDGE PC, 1751 PINNACLE DRIVE, SUITE 500, MCLEAN, VA, 22102-3833, US

(21) Appl. No.: 12/281,777

(22) PCT Filed: Jun. 7, 2006
(86) PCT No.: PCT/JP2006/311449

§ 371 Date: Dec. 23, 2008

(51) Int. Cl. H01J 17/49

(52) U.S. Cl. 313/585

(57) ABSTRACT

A plasma display panel (1, 2, 3) is provided with first display electrodes (X, Xb), second display electrodes (Y, Yb), address electrodes (A, Ab), and a partition (23) that is mesh-like in a plan view. The partition (23) is configured from a plurality of vertical wall portions (24), a plurality of first horizontal wall portions (25) that partially overlap the first display electrodes (X, Xb), and a plurality of second horizontal wall portions (26) that partially overlap the second display electrodes (Y, Yb). In the plasma display panel (1, 2, 3), gaps (32, 33) that pass through a discharge gas space (31) of a plurality of cells (51) are present between the partition (23) and the first display electrodes (X, Xb), and a plan view distance (D2) between the second horizontal wall portion (26) and a surface discharge gap (60) is greater than a plan view distance (D1) between the first horizontal wall portion (25) and the surface discharge gap (60).

### TECHNICAL FIELD

The present invention relates to a surface discharge-type plasma display panel provided with a partition that partitions a discharge gas space corresponding to a cell arrangement of a screen, and is mesh-like in a plan view, enclosing the discharge gas space that corresponds to each cell.

### BACKGROUND ART

Three-electrode surface discharge-type plasma display panels are used for displaying color images. In the format of this three-electrode surface discharge-type plasma display panel, first and second display electrodes for producing a display discharge are arranged parallel to each other on a front panel or a back panel, and address electrodes are arranged on the front panel or the back panel such that they intersect with the display electrodes to configure an electrode matrix. In this format, the display electrodes and the address electrodes oppose each other via a discharge gas space.

When displaying an image, an operation is performed to write data (addressing) in a line-sequential scanning format that forms an appropriate amount of wall charge in only cells to be energized among cells arranged in a matrix on a screen, and afterward the wall charge is used to perform an operation to maintain lighting (sustain) that produces a display charge a number of times corresponding to gradation values of display data. In the addressing, the second display electrodes are used as scan electrodes for display line selection, and the address electrodes are used as data electrodes that output display data. In the sustain, the first and second display electrodes are used as anodes and cathodes for surface discharge.

There are two modes of arranging display electrodes for surface discharge. For the sake of convenience, one of those will be referred to as an independent-type arrangement, and the other will be referred to as a shared-type arrangement. In the independent-type arrangement, display electrodes are arranged in pairs, with one pair for each display line corresponding to a row of the matrix display. The total number of display electrodes is twice the vertical resolution (number of display lines). With the independent-type arrangement, it is possible to realize progressive display with a comparatively simple drive sequence, because each display line is independently controlled. In the shared-type arrangement, a number of display electrodes obtained by adding 1 to the number of display lines are arranged at uniform intervals. With the shared-type arrangement, display electrodes that are adjacent to each other constitute an electrode pair for surface discharge, and each gap between the display electrodes becomes a surface discharge gap. The usage ratio of the screen is higher for a shared-type arrangement than for an independent-type arrangement.

In the case of both the independent-type arrangement and the shared-type arrangement, discharge occurs between parallel display electrodes, so a partition (discharge barrier) is necessary that prevents at least discharge interference between cells lined up along display electrodes. That is, a plurality of strip-like partitions that divide the discharge gas space are necessary for each column of the matrix display. This sort of partition disposing pattern is called a stripe pattern. A stripe pattern is made up of only vertical walls that extend in the vertical direction of the screen.

An example of another partition disposing pattern is a mesh pattern (also referred to as a closed-type pattern). In a mesh pattern, the discharge gas space is divided for each column and for each row (that is, for each cell) of the matrix display. The partition in a mesh pattern is configured from vertical walls that extend in the vertical direction of the screen, and horizontal walls that extend in the horizontal direction of the screen, throughout the entire screen. With this configuration, the four sides of the discharge gas space of each cell are enclosed, so discharge interference is prevented not only in the horizontal direction, but also in the vertical direction. The mesh pattern is useful for increasing fineness of a screen with an independent-type electrode arrangement (improving the vertical resolution), and is also suitable for progressive display by a screen with a shared-type electrode arrangement.

JP 2002-83545A discloses a plasma display panel constituted from a front panel having an independent-type display electrode arrangement and a back panel having a mesh-patterned partition, and a plasma display panel constituted from a front panel having a shared-type display electrode arrangement and a back panel having a mesh-patterned partition. In the disclosed independent-type display electrode arrangement, in adjacent display lines, the first display electrode and the second display electrode are at opposing positions in the vertical direction, and each of the first display electrodes constituted from a transparent conductive film and a metal film (bus conductor), and each of the second display electrodes constituted in the same manner, partially overlap with the horizontal wall portion in the partition. A metal film is disposed in that overlapping portion, and thus the metal film does not block display light. With the shared-type arrangement, each display electrode corresponds to two adjacent display lines, so the display electrode necessarily partially overlaps with the horizontal wall in the partition.

Also, in above JP 2002-83545A, technology is disclosed for forming the horizontal wall lower than the vertical wall, using the fact that the degree of heat shrinkage of the partition material depends on the pattern width. In a state in which the upper face of the horizontal wall is in contact with the front panel, a gap is present between the vertical wall and the front panel. This gap allows for good air exhaust and good ventilation of gas filling during production of the plasma display panel.

### Patent Document 1: JP 2002-83545A

### DISCLOSURE OF THE INVENTION

In the production of plasma display panels, the efficiency of air exhaust to purify internal space, performed after the front panel and the back panel are glued together, greatly affects the electrical properties of the screen. Because exhaust air conductance is low, when there is inadequate removal of impurities, it is easy for display unevenness to occur that are caused by a reduction in luminance due to a deterioration in fluorescent material for color display or fluctuation in discharge start voltage, and variation in the amount of change in the discharge start voltage.

Exhaust air conductance is less in the center portion of the screen than in the peripheral portion, so it will probably become more and more difficult to expel impurities with increases in the size and fineness of future screens. Accordingly, increasing the air exhaust efficiency is important for realizing high grade, high quality plasma display panels. In particular, in a plasma display panel with a box rib structure having a mesh-patterned partition, the air exhaust conductance is less than in a plasma display panel with a straight rib structure having a stripe-patterned partition arrangement, so some way of securing an air exhaust path is essential.

On the other hand, in a plasma display panel with a box rib structure, horizontal wall portions are present, so the effective opposing area that contributes to address discharge of a scan electrode (second display electrode) that opposes the address electrode is less than in a plasma display panel with a straight rib structure. The smaller the effective opposing area is, the smaller the probability of address discharge will be, and so the easier it will be for an address discharge error to occur. FIG. 9 shows the relationship between effective opposing area and lighting address voltage. Lighting address voltage is the voltage when the address voltage applied between the scan electrode and the address electrode is gradually increased so that address discharge has occurred normally. In the example shown in FIG. 9, when the effective opposing area is approximately 25,000 μm² or less, the lighting address voltage abruptly increases. This means that when the effective opposing area is approximately 25,000 μm² or less, an address discharge error will occur unless a sufficiently high address voltage is applied.

In the course of production, shrinkage of the substrate or slight positional difference between the front panel and the back panel is unavoidable, so the effective opposing area varies between cells. In order to reduce the influence of this variation on a driving voltage margin, it is desirable to make the effective opposing area as large as possible in a cell with limited dimensions.

It is an object of the invention to provide a plasma display panel that has an improved box rib structure and is useful for increasing the efficiency of air exhaust in production and reducing address discharge errors.

A plasma display panel that attains the above object is provided with a screen in which display lines are set at equal intervals and that includes cells that emit light due to electric discharge, a first substrate and a second substrate that are opposing each other and sandwich a discharge gas space therebetween, first display electrodes and a second display electrodes that are arranged on the first substrate and extend in a first direction along the display lines, address electrodes that are arranged on the second substrate and extend in a second direction that intersects with the first direction, a partition that is mesh-like in a plan view and is fixed to the second substrate, the partition partitioning the discharge gas space corresponding to a cell arrangement of the screen, with one first display electrode and one second display electrode corresponding to each of the display lines, and in each cell in which these pairs of first and second display electrodes correspond to the display lines, a surface discharge gap being formed, and furthermore in adjacent display lines, the first display electrode and the second display electrode being reversely positioned in the second direction, the partition being configured from a plurality of vertical wall portions that extend in the second direction and intersect with the first and the second display electrodes, a plurality of first horizontal wall portions that extend in the first direction and partially overlap only the first display electrodes of the first and the second display electrodes, and a plurality of second horizontal wall portions that extend in the first direction and partially overlap only the second display electrodes of the first and the second display electrodes, a width of each of the plurality of first horizontal wall portions in the second direction being greater than a width of each of the plurality of second horizontal wall portions in the second direction, a gap that passes through a discharge gas space of a plurality of cells being present between the partition and the first display electrode, and in each cell of the screen, a plan view distance between the second horizontal wall portion and the surface discharge gap being greater than a plan view distance between the first horizontal wall portion and the surface discharge gap.

The arrangement of the display electrodes may be an independent-type arrangement or a shared-type arrangement. In the case of an independent-type arrangement, each of the plurality of first display electrodes corresponds to only one display line, and each of the plurality of second display electrodes corresponds to only one display line. In the case of a shared-type arrangement, each of the plurality of first display electrodes corresponds to two adjacent display lines, and each of the plurality of second display electrodes corresponds to two adjacent display lines.

By reducing the width of the second horizontal wall portions, the area of a portion that opposes the address electrode in the second display electrode is increased. By making the width of the first horizontal wall portions larger than the width of the second horizontal wall portions, it is possible to obtain a gap that passes through the discharge gas space of a plurality of cells with the technology described in above Patent Document 1 that uses the heat shrinking properties of the partition material.

### BRIEF DESCRIPTION OF THE DRAWINGS

FIG. 1 is a front view that shows the overall configuration of a plasma display panel.

FIG. 2 shows the color arrangement of a typical screen.

FIG. 3 is an exploded perspective view that shows the cell structure of the plasma display panel.

FIG. 4 shows the shape of a partition and the shape of an address electrode.

FIG. 5 shows the shape of display electrodes and the relative positions of the display electrodes and the partition.

FIG. 6 is a schematic diagram of the cross-sectional structure of relevant parts of the plasma display panel.

FIG. 7 shows a modified example of the shape and arrangement of the display electrodes.

FIG. 8 shows a modified example of the shape of the address electrode.

FIG. 9 shows the relationship between effective opposing area and lighting address voltage.

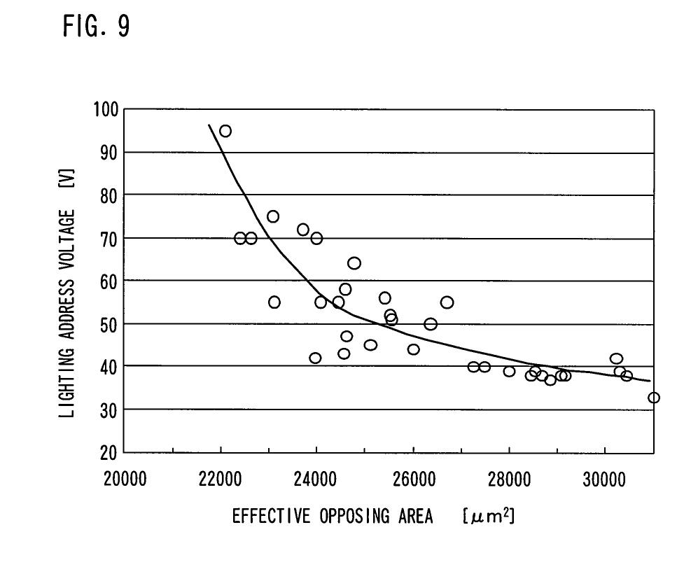

### BEST MODE FOR CARRYING OUT THE INVENTION

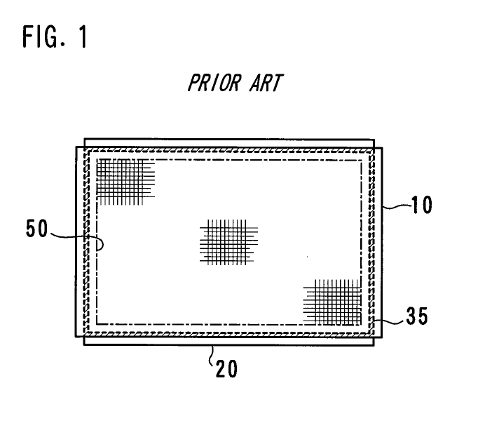

As shown in FIG. 1, a plasma display panel has a front panel 10, a back panel 20, and a screen 50 constituted from a large number of cells (light emitting elements) arranged in a matrix and a discharge gas (not shown). For example, when the screen size is 42 inches diagonally, the plasma display panel size is about 994 mm×585 mm. The front panel 10 and the back panel 20 both are members in which a plurality of layers that include electrodes are fixed to an approximately 3 mm-thick glass substrate that is larger than the screen 50. The front panel 10 and the back panel 20 are disposed opposing each other so as to overlap, and are joined with a frame-like sealing material 35 disposed in the peripheral portion of the region where they overlap each other. Discharge gas is sealed within the internal space sealed up by the front panel 10, the back panel 20, and the sealing material 35.

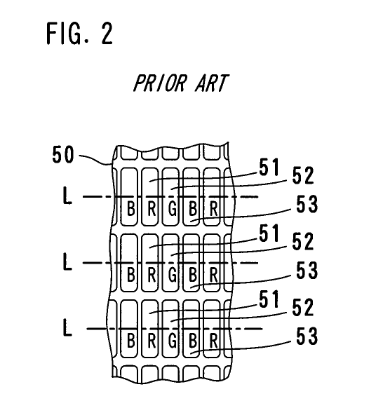

As shown in FIG. 2, display lines L are set at uniform intervals in the screen 50. Each display line L corresponds to one row of the matrix display, and extends in the horizontal direction (a first direction) of the screen 50. Along each display line L, cells 51 that are red light emitting elements, cells 52 that are green light emitting elements, and cells 53 that are blue light emitting elements are lined up. The color arrangement in the screen 50 is a striped arrangement in which the emitted light color of cells lined up in the vertical direction (a second direction) corresponding to one column of the matrix display is the same, and the emitted light color is different from that of adjacent columns. Three cells lined up in the horizontal direction correspond to one pixel of an image.

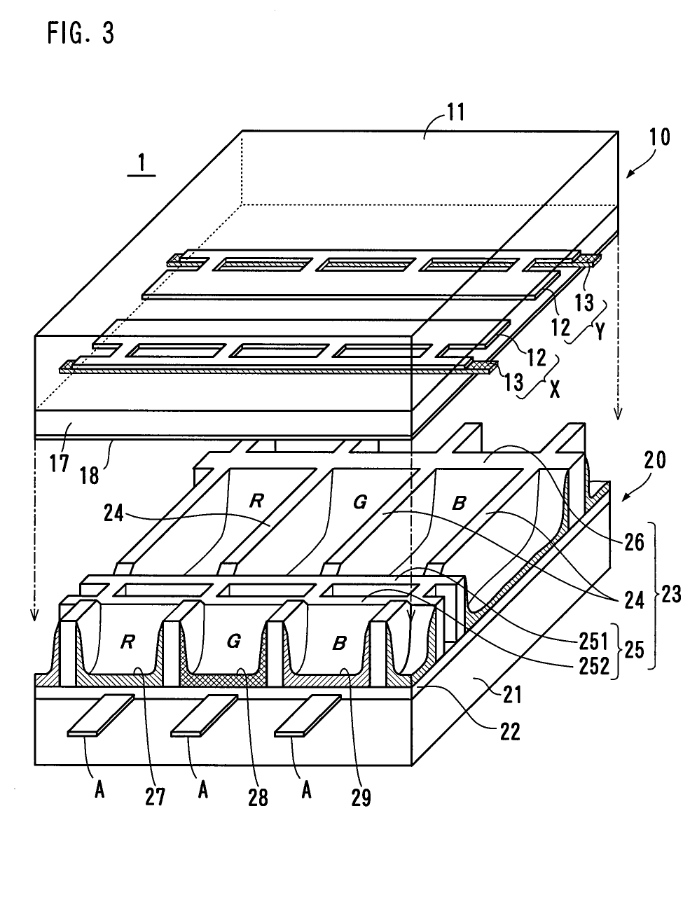

The screen 50 has the cell structure shown in FIG. 3. In FIG. 3, the front panel 10 and the back panel 20 are shown separated from each other, for ease of understanding the inner structure.

The front panel 10 is provided with a glass substrate 11, first display electrodes X, second display electrodes Y, a dielectric layer 17, and a protective film 18. The back panel 20 is provided with a glass substrate 21, address electrodes A, a dielectric layer 22, a partition 23, a red (R) fluorescent material 27, a green (G) fluorescent material 28, and a blue (B) fluorescent material 29.

The display electrodes X and Y are arranged on an inner face of the glass substrate 11 as electrodes for producing surface discharge. Each of these electrodes includes a patterned transparent conductive film 12 and a metal film 13, and extends in the horizontal direction. The dielectric layer 17 is spread out over the entire screen, and covers the display electrodes X and Y. The protective film 18 prevents sputtering on the dielectric layer 17.

The address electrodes A extend in the vertical direction (the second direction) of the screen, and intersect with the display electrodes X and Y. A partition 23 formed on the dielectric layer 22 that covers the address electrodes A prevents discharge interference between cells, and also functions as a spacer that establishes a uniform thickness of the discharge gas space in the screen. The fluorescent materials 27, 28, and 29 cover the surface of the dielectric layer 22 and the side faces of the partition 23 in the corresponding cells, and are excited by ultraviolet light discharged by the discharge gas, thus emitting light.

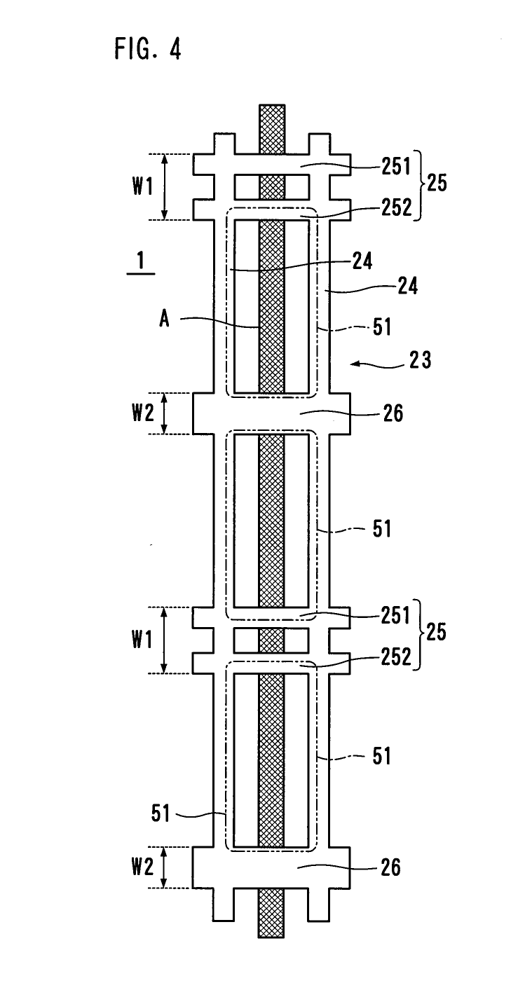

The partition 23 is a characteristic constituent element of a plasma display panel 1. Also referring to FIG. 4, the partition 23 includes a plurality of vertical wall portions 24 that extend in the vertical direction of the screen and intersect with the display electrodes X and Y, a plurality of first horizontal wall portions 25 that extend in the horizontal direction and partially overlap only the display electrodes X, and a plurality of second horizontal wall portions 26 that extend in the horizontal direction and partially overlap only the display electrodes Y. Furthermore, in this example, each of the plurality of first horizontal wall portions 25 includes a horizontal wall 251 that extends in the horizontal direction and a horizontal wall 252 that is parallel to the horizontal wall 251. The dielectric constant of the discharge gas is about ⅛ of low melting point glass, which is the partition material, so the gap between the horizontal walls 251 and 252 contributes to a reduction in capacitance of the cells. As shown in FIG. 4, the vertical width W1 of the first horizontal wall portions 25 is larger than the vertical width W2 of the second horizontal wall portions 26.

As is clearly shown in FIG. 3, the first horizontal wall portion 25 is lower than the vertical wall portion 24 and the second horizontal wall portion 26. The height difference is about 10 μm, for example. Due to this height difference, while having a box rib structure, an air exhaust path is formed that extends in the horizontal direction in the screen. Note that in FIG. 3, the entire first horizontal wall portion 25 is lower than the vertical wall portion 24 and the second horizontal wall portion 26, but the structure of the first horizontal wall portion 25 is not limited thereto. Even if the structure is such that only a part of the first horizontal wall portion 25 that is near the vertical wall portion 24 is low, an air exhaust path that extends in the horizontal direction will be formed.

This sort of partition 23 is formed by baking low melting point glass, with the vertical wall portion 24, the first horizontal wall portion 25, and the second horizontal wall portion 26 being formed together at the same time. When baking a material that has heat-shrinking properties such as ordinary low melting point glass, the amount of shrinkage in the height direction depends on the pattern width. In a portion where the pattern width is small, shrinkage is possible overall in two directions, i.e. the width direction and the height direction, but in a portion where the pattern width is large, shrinkage in the width direction is suppressed closer to the center in the width direction, and the large pattern width portion shrinks greatly in the height direction by the amount of that suppression. Accordingly, even when the thick first horizontal wall portion 25 includes two horizontal walls as shown in this example, the first horizontal wall portion 25 becomes lower than the thin second horizontal wall portion 26.

In this example, the thick first horizontal wall portion 25 includes the two horizontal walls 251 and 252, but the structure of the first horizontal wall portion 25 is not limited thereto. According to the gist of the invention, the first horizontal wall portion 25 may also be one thick horizontal wall, or may include three or more horizontal walls.

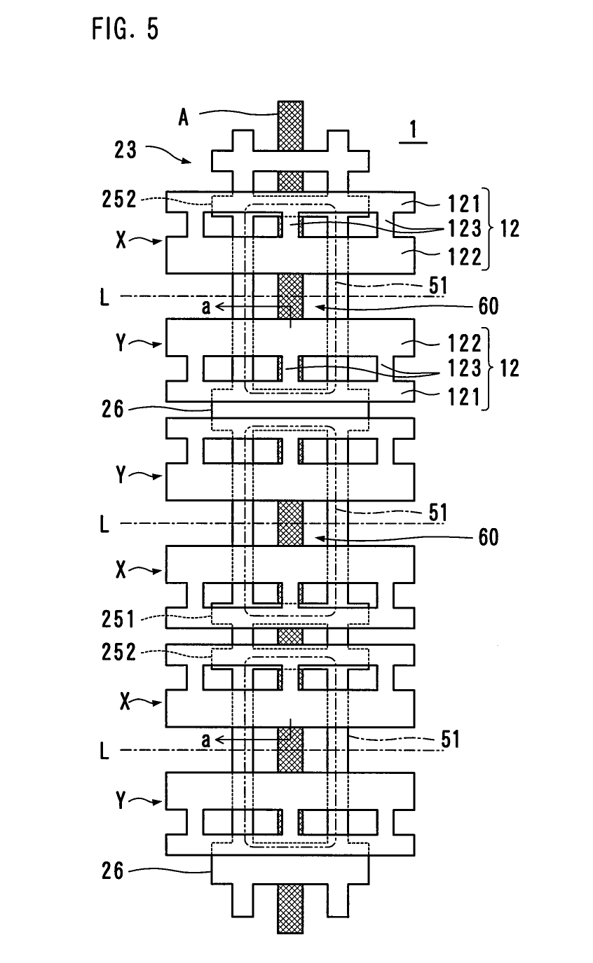

As shown in FIG. 5, the display electrode arrangement of the plasma display panel 1 is an independent-type arrangement. Each display line L corresponds to one display electrode X and one display electrode Y, and a pair of the display electrodes X and Y forms a surface discharge gap 60 in each of the plurality of cells 51 corresponding to the display line L. However, between each display line L and another display line L adjacent thereto, the positions of the display electrodes X and Y in the vertical direction (the vertical direction in FIG. 5) are reversed. That is, in one display line L of display lines L that are adjacent to each other, the display electrodes are lined up in the order X, Y from top to bottom in FIG. 5, and in the other display line L, the display electrodes are lined up in the order Y, X.

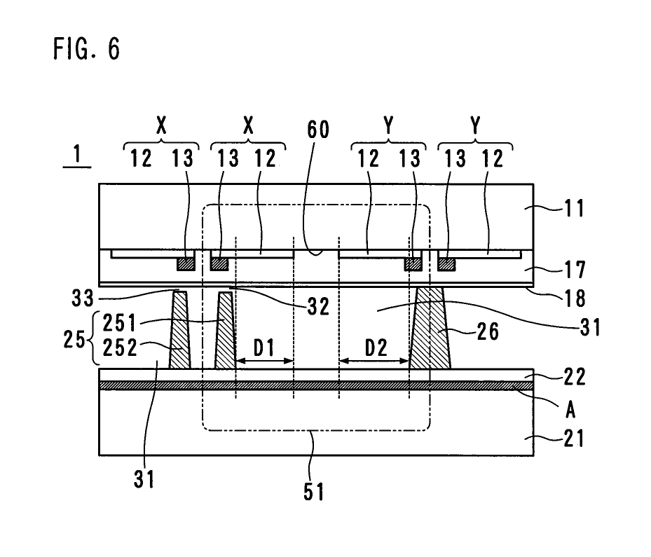

The transparent conductive film 12 of the display electrode X includes a power supply portion 121 on which the metal film 13, omitted from FIG. 5 (see FIGS. 3 and 6), is laminated, a strip-like discharge portion 122 that is parallel to the power supply portion 121, and a plurality of connecting portions 123 that join the power supply portion 121 and the discharge portion 122. One connecting portion 123 is disposed in each cell 51. The power supply portion 121 overlaps the horizontal wall 251 or 252.

Likewise, the transparent conductive film 12 of the display electrode Y includes a power supply portion 121 on which the metal film 13, omitted from FIG. 5, is laminated, a strip-like discharge portion 122 that is parallel to the power supply portion 121, and a plurality of connecting portions 123 that join the power supply portion 121 and the discharge portion 122. The power supply portion 121 overlaps the second horizontal wall portion 26.

FIG. 6 shows a cross-sectional structure that corresponds to a view in the direction of arrows a-a in FIG. 5. However, fluorescent materials are omitted from FIG. 6.

As described above, the first horizontal wall portion 25 is lower than other parts of the partition 23, so between the first display electrodes X and the first horizontal wall portion 25, gaps 32 and 33 are present that pass through a discharge gas space 31 of a plurality of cells. These gaps 32 and 33 are part of an air exhaust path.

Also, in the individual cells 51, a plan view distance D2 between the second horizontal wall portion 26 and the surface discharge gap 60 is longer than a plan view distance D1 between the first horizontal wall portion 25 and the surface discharge gap 60. That is, the opposing area (effective opposing area) of the discharge portions of the display electrodes Y, used as scan electrodes, and the address electrode A is greater than the opposing area of the discharge portions of the display electrodes X and the address electrode A. Accordingly, address discharge errors are less likely to occur in the cell 51 than in a case where the plan view distance D2 is the same as the plan view distance D1.

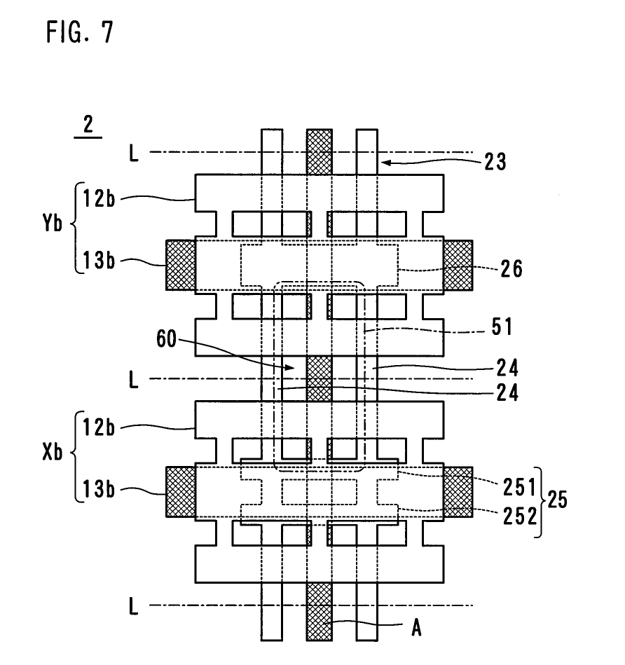

FIG. 7 shows a modified example of the shape and arrangement of the display electrodes. The display electrode arrangement of a plasma display panel 2 in FIG. 7 is a shared-type arrangement. The shape and the layer structure are the same for a display electrode Xb and a display electrode Yb. The display electrode Xb and the display electrode Yb each include a transparent conductive film 12b and a metal film 13b. The metal film 13b of the display electrode Xb overlaps both the horizontal wall 251 and the horizontal wall 252 that constitute the first horizontal wall portion 25. The metal film 13b of the display electrode Yb overlaps the second horizontal wall portion 26.

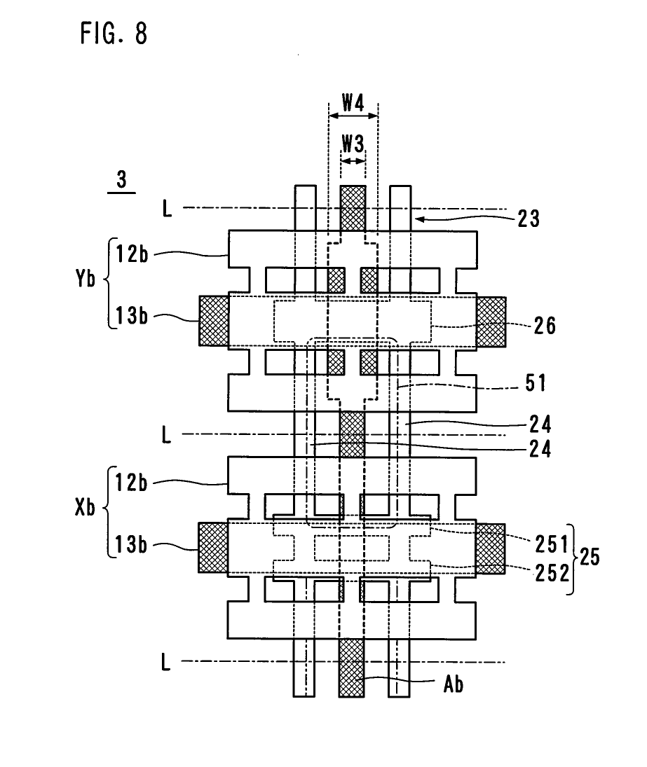

FIG. 8 shows a modified example of the shape and arrangement of the address electrode. In a plasma display panel 3 shown in FIG. 8, an address electrode Ab is formed in a strip-like shape, with part of the strip being wider in order to increase the effective opposing area for address discharge. That is, the address electrode Ab has a pad (an enlarged portion) for address discharge. In the address electrode Ab, a width W4 of the part that intersects with the display electrode Yb is larger than a width W3 of the part that intersects with the display electrode Xb. It is desirable that not only in the case of the shared-type arrangement shown in FIGS. 7 and 8, but also in the case of an independent-type arrangement, a pad is disposed symmetrically relative to the center in the vertical direction of the second horizontal wall portion 26.

In the above embodiments, the shape of the electrodes and the partition can be appropriately modified in accordance with the gist of the invention. The transparent conductive films 12 and 12b are not limited to having a strip-like shape throughout the entire length of the display lines L; they may have an island shape (including a quadrilateral shape, a T-shape, and an I-shape) that is independent for each cell. The height and the pattern width of the partition 23 may be selected according to the cell size.

### INDUSTRIAL APPLICABILITY

The present invention contributes to improving the properties of plasma display panels.

1. A plasma display panel comprising:
a screen in which display lines are set at equal intervals and that includes cells that emit light due to electric discharge;
a first substrate and a second substrate that are opposing each other and sandwich a discharge gas space therebetween, first display electrodes and second display electrodes that are arranged on the first substrate and extend in a first direction along the display lines;
address electrodes that are arranged on the second substrate and extend in a second direction that intersects with the first direction;
a partition that is mesh-like in a plan view and is fixed to the second substrate,
the partition partitioning the discharge gas space corresponding to a cell arrangement of the screen, with one first display electrode and one second display electrode corresponding to each of the display lines, and in each cell in which these pairs of first and second display electrodes correspond to the display lines, a surface discharge gap being formed, and furthermore
in adjacent display lines, the first display electrode and the second display electrode being reversely positioned in the second direction,
the partition being configured from
a plurality of vertical wall portions that extend in the second direction and intersect with the first and the second display electrodes;
a plurality of first horizontal wall portions that extend in the first direction and partially overlap only the first display electrodes of the first and the second display electrodes; and
a plurality of second horizontal wall portions that extend in the first direction and partially overlap only the second display electrodes of the first and the second display electrodes,
a width of each of the plurality of first horizontal wall portions in the second direction being greater than a width of each of the plurality of second horizontal wall portions in the second direction;
a gap that passes through a discharge gas space of a plurality of cells being present between the partition and the first display electrode; and
in each cell of the screen, a plan view distance between the second horizontal wall portion and the surface discharge gap being greater than a plan view distance between the first horizontal wall portion and the surface discharge gap.

2. The plasma display panel according to claim 1, wherein each of the plurality of first display electrodes corresponds to only one display line, and each of the plurality of second display electrodes corresponds to only one display line.

3. The plasma display panel according to claim 1, wherein each of the plurality of first display electrodes corresponds to two adjacent display lines, and each of the plurality of second display electrodes corresponds to two adjacent display lines.

4. The plasma display panel according to claim 1, wherein the first horizontal wall portion is composed of a plurality of horizontal walls that extend in the first direction.

5. The plasma display panel according to claim 1, wherein a width of each part of the address electrodes that intersects with the second display electrode is greater than a width of each part of the address electrodes that intersects with the first display electrode.
